(19) United States
(12) Patent Application Publication
(10) Pub. No.: US 2008/0101367 A1
(43) Pub. Date: May 1, 2008

(54) METHOD AND APPARATUS FOR PROVIDING SECURITY POLICY BASED ROUTE SELECTION

(76) Inventor: Joseph B. Weinman, Basking Ridge, NJ (US)

Correspondence Address: Mr. John Etchells;AT&T Enterprise Services, Inc., Room 2A-207, One AT&T Way, Bedminster, NJ, 07921, US

(21) Appl. No.: 11/555,191

(22) Filed: Oct. 31, 2006

(51) Int. Cl. H04L 12/56

(52) U.S. Cl. 370/392; 370/401

(57) ABSTRACT

A method and apparatus for selecting routes for packet transmission based on a security policy are disclosed. For example, the present method receives one or more packets and determines a security policy associated with the packets. The method then selects a route for transmission of the one or more packets based on the security policy.

The present invention relates generally to communication networks and, more particularly, to a method and apparatus for selecting routes based on security policy for packets transmitted over networks such as packet networks, e.g., Internet Protocol (IP) networks, Multi-protocol Label Switching (MPLS), Voice over Internet Protocol (VoIP) and Service over Internet Protocol (SoIP) networks.

### BACKGROUND OF THE INVENTION

Internet Protocol transport networks and services such as VoIP and SoIP services are becoming ubiquitous and businesses and consumers are relying on their Internet Protocol connections to obtain much of their communications services. The routing of packets towards their destination through a private enterprise network or network service provider's network is facilitated via routers. Generally, a router may have access to more than one possible path for a packet forwarding, from which the router will choose a next hop for the packet. In order to choose the best path, routers and ancillary equipment such as route reflectors build and maintain routing tables with information that may be used for route selection, e.g., routers associate a next-hop based on destination IP address, etc. The content of the routing table may be built based on algorithms such as Open Shortest Path First (OSPF). The algorithms compare path length, cost, congestion, etc. The routing table is then populated for various destinations. The path selection for a packet is made based on the destination address of the packet and the content of the routing table. However, a customer may have concerns relating to security and may have different routing requirements for different types of transactions.

Therefore, there is a need for a method that enables a service provider to provide security policy based route selection.

### SUMMARY OF THE INVENTION

In one embodiment, the present invention discloses a method and apparatus for providing security policy based route selection on networks such as packet networks. The method receives one or more packets and determines at least one security policy associated with said one or more packets. The method then selects a route for transmission of said one or more packets based on said security policy.

### BRIEF DESCRIPTION OF THE DRAWINGS

The teaching of the present invention can be readily understood by considering the following detailed description in conjunction with the accompanying drawings, in which:

FIG. 1 illustrates an exemplary network related to the present invention;

FIG. 2 illustrates an exemplary network with the current invention for providing security policy based route selection;

FIG. 3 illustrates a flowchart of a method for providing security policy based route selection; and

FIG. 4 illustrates a high-level block diagram of a general-purpose computer suitable for use in performing the functions described herein.

To facilitate understanding, identical reference numerals have been used, where possible, to designate identical elements that are common to the figures.

### DETAILED DESCRIPTION

The present invention broadly discloses a method and apparatus for providing security policy based route selection on networks such as the packet networks, e.g., IP/MPLS, Voice over Internet Protocol (VoIP) and Service over Internet Protocol (SoIP) networks. Although the present invention is discussed below in the context of IP networks, the present invention is not so limited. Namely, the present invention can be applied for other networks such as the cellular networks and the like.

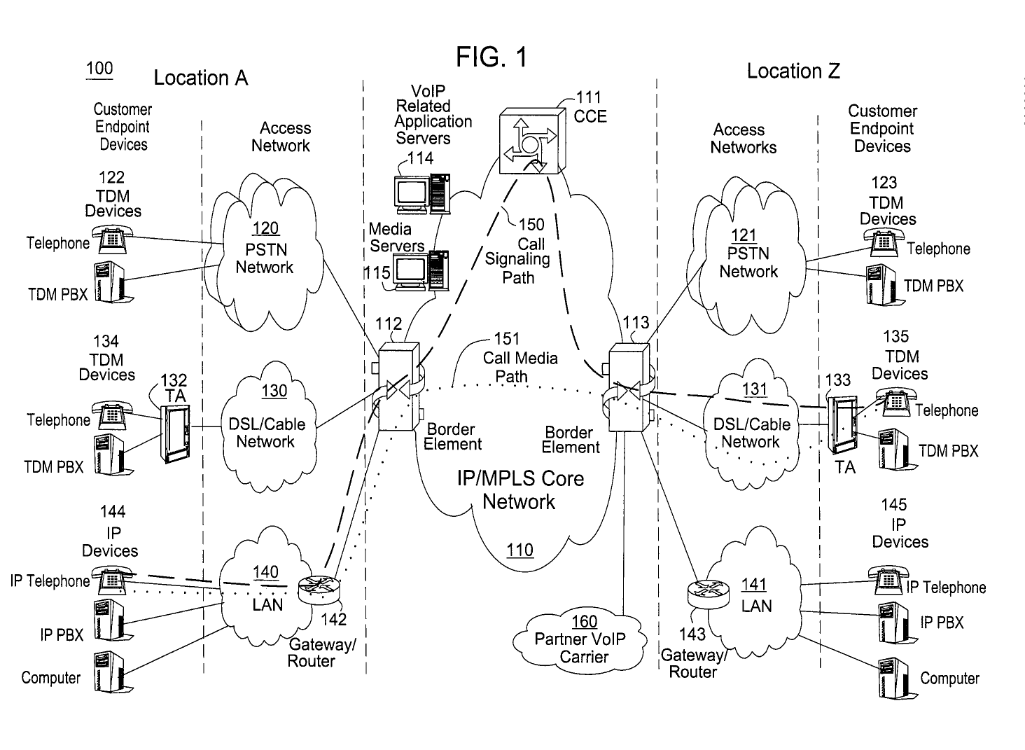

To better understand the present invention, FIG. 1 illustrates an exemplary converged network 100, e.g., a packet network such as a converged data, VoIP, video over IP, and/or any service over IP network related to the present invention. Exemplary packet networks include Internet protocol (IP) networks, MPLS networks, Asynchronous Transfer Mode (ATM) networks, frame-relay networks, and the like. An IP network is broadly defined as a network that uses Internet Protocol to exchange data packets. Thus, a Voice over Internet Protocol (VoIP) network or a Service over Internet Protocol (SoIP) network is considered an IP network.

In one embodiment, the converged network may comprise various types of customer endpoint devices connected via various types of access networks to a carrier (a service provider) VoIP core infrastructure over an Internet Protocol/Multi-Protocol Label Switching (IP/MPLS) based core backbone network. Broadly defined, a converged network is a network that is capable of carrying voice signals, video signals, and data, such as email or files as packetized data over an IP network. The present invention is described below in the context of an illustrative converged network. Thus, the present invention should not be interpreted as limited by this particular illustrative architecture.

The customer endpoint devices can be either Time Division Multiplexing (TDM) based or IP based. TDM based customer endpoint devices 122, 123, 134, and 135 typically comprise of TDM phones or Private Branch Exchange (PBX). IP based customer endpoint devices 144 and 145 typically comprise IP phones or IP PBX. The Terminal Adaptors (TA) 132 and 133 are used to provide necessary interworking functions between TDM customer endpoint devices, such as analog phones, and packet based access network technologies, such as Digital Subscriber Loop (DSL) or Cable broadband access networks. TDM based customer endpoint devices access VoIP services by using either a Public Switched Telephone Network (PSTN) 120, 121 or a broadband access network 130, 131 via a TA 132 or 133. IP based customer endpoint devices access VoIP services by using a Local Area Network (LAN) 140 and 141 with a VoIP gateway or router 142 and 143, respectively. Other IP-based customer devices may include computers, servers, laptops, mobile devices with IP connectivity, network attached storage devices, Storage Area Networks (SANs), content addressed storage devices, SAN fabric switches, and the like.

The access networks can be either TDM or packet based. A TDM PSTN 120 or 121 is used to support TDM customer endpoint devices connected via traditional phone lines. A packet based access network, such as Frame Relay, ATM, Ethernet or IP, is used to support IP based customer endpoint devices via a customer LAN, e.g., 140 with a VoIP gateway and/or router 142. A packet based access network 130 or 131, such as DSL or Cable, when used together with a TA 132 or 133, is used to support TDM based customer endpoint devices.

The core converged network infrastructure may comprise several key components, such as the Border Elements (BEs) 112 and 113, the Call Control Element (CCE) 111, data, VoIP, and/or video over IP related Application Servers (AS) 114, and Media Server (MS) 115. The BE resides at the edge of the converged network core infrastructure and interfaces with customers endpoints over various types of access networks. A BE may be typically implemented as a Media Gateway and performs signaling, media control, security, and call admission control and related functions. The CCE resides within the VoIP infrastructure and is connected to the BEs using the Session Initiation Protocol (SIP) over the underlying IP/MPLS based core backbone network 110. The CCE is typically implemented as a Media Gateway Controller or a softswitch and performs network wide call control related functions as well as interacts with the appropriate VoIP, video or data service related servers when necessary. The CCE functions as a SIP back-to-back user agent and is a signaling endpoint for all call legs between all BEs and the CCE. The CCE may need to interact with various VoIP related Application Servers (AS) in order to complete a call that requires certain service specific features, e.g. translation of an E.164 voice network address into an IP address and so on. For calls that originate or terminate in a different carrier, they can be handled through the PSTN 120 and 121 or the Partner IP Carrier 160 interconnections. A customer in location A using any endpoint device type with its associated access network type can communicate with another customer in location Z using any endpoint device type with its associated network type.

The above converged network is described to provide an illustrative environment in which data and voice packets are transmitted on communication networks. The packets are forwarded towards their destination through an enterprise network or network service provider's network via routers. For simplicity, we will sometimes use the term service provider's network to include all variations of a commercial service provider, such as a common carrier, an internal service provider (e.g., the IT/Telecom department), a third party wholesaler, and combinations therein. Generally, a router may have access to more than one possible path for a packet transmission, from which the router will choose a path for the packet. In order to choose the best path, each router builds and maintains a routing table to be used for route selection, e.g., the router associates a next-hop for each known destination IP address, subnet, or network, etc. For example, the routing table is built based on routing algorithms such as Open Shortest Path First (OSPF) protocol that compare path length, cost, etc. The route selection is then made based on the destination address of the packet and the routing table. However, as more and more critical applications are being supported on the IP network, more and more application dependent requirements are imposed on the IP network. For example, a customer may have different routing requirements based on security policy. For example, a packet with sensitive information may need to be routed via specific routers. In another example, a packet may need to be routed while avoiding a list of intermediate networks, e.g., avoiding routers in a specific region, or avoiding routers with known security issues, and so on.

The present invention provides a method and apparatus for providing security policy based route selection on networks such as the packet networks, e.g., VoIP and SoIP networks. In order to clearly illustrate the current invention, the following network related terminology will first be provided:

Encryption; and

IP Security (IPSec).

Encryption refers to algorithmic schemes that encode data into non-readable form or cyphertext, thereby providing privacy. The receiver of the encrypted data uses a “key” to decrypt the encoded data, thereby returning it to its original form.

IP Security (IPSec) refers to a set of standard protocols developed to support secure exchange of packets over the IP layer. IPSec provides security services for other Transmission Control Protocol over Internet Protocols (TCP/IP) and applications. For example, in order to communicate securely, a source and a destination TCP/IP device set up a secure communication path over the Internet using IPSec. The source and destination devices must first agree on a set of protocols to be used for communication, encryption techniques and keys to be used to unlock the received data. The devices then use the agreed upon protocols, encryption techniques and keys to encode the data, send it over the IP network and receive it at the destination. Using IPSec and encryption enables the information to be encoded to make it more difficult to decode without prior knowledge of the key.

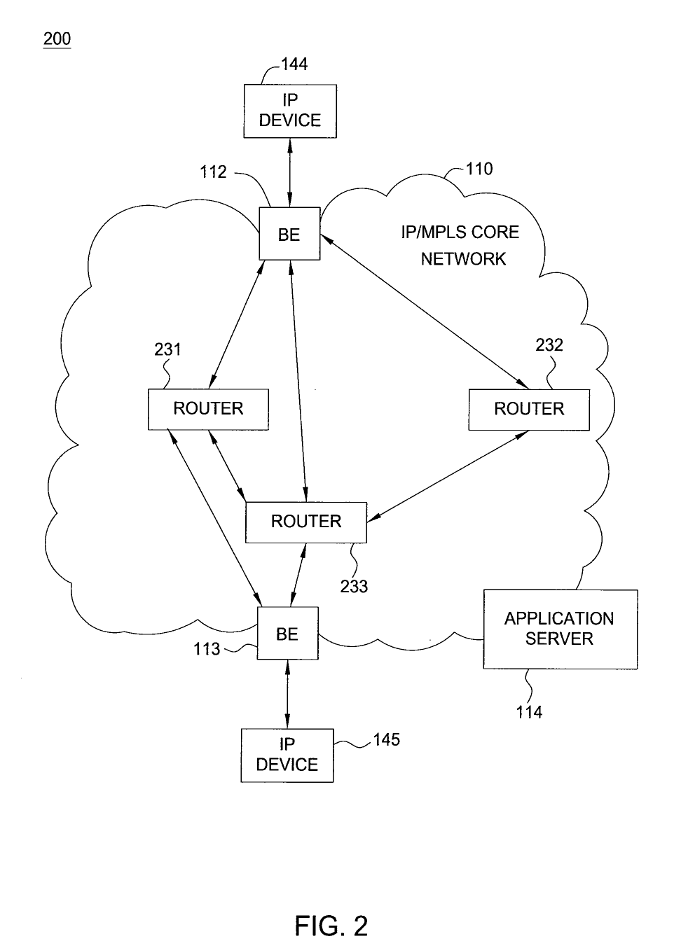

FIG. 2 illustrates an exemplary network 200 with one embodiment of the current invention for providing security policy based route selection. For example, a customer is using IP device 144 to access IP services such as file transfer, storage replication, video over IP, VoIP and/or SoIP services. IP device 144 is connected to the Border Element (BE) 112 located on the IP/MPLS core network 110. It should be appreciated that the Border Element may in fact be a Provider Edge router, or an enterprise router connected to the IP device. The routers 231, 232 and 233 are part of the IP/MPLS core network 110 and are used to route packets to IP device 145. The packets traverse the core network from BE 112 to BE 113 via one or more routers in the core network 110. For example, the packets may traverse from BE 112 to router 231 then to BE 113, or BE 112 to router 231 to router 233 and then to BE 113, or BE 112 to router 233 and then to BE 113, and so on. In one embodiment, the various routes from BE 112 to BE 113 may provide various levels of security. For example, one route may be used for packets with high security requirements (e.g., via router 231) while all other routes (e.g., via routers 232 and 233) may be used for packets with lower security requirements. The packets are then forwarded to the IP device 145 connected to the border element 113. Note that each router maintains a routing table for forwarding packets towards their destination. The IP/MPLS core network may also include an application server 114 for directly or indirectly interacting with customers, and implementing security policy based route selection. As an example of direct interaction, customers may specify, through a portal (not shown) to the application server, rules such as that messages matching a particular pattern or rule shall be sent according to a particular route, those matching a different pattern or rule shall be sent according to a different route. As an example of indirect interaction, customer data traversing the network among routers 231, 232, and 233 may include control packets specifying such rules. Note that only the network elements used to describe the present invention are illustrated in FIG. 2. As such, network 200 may contain other network components that are not illustrated in FIG. 2.

In one embodiment, the service provider enables one or more routers to determine the security policy associated with one or more packets. For example, a router may examine a packet to determine the security policy associated with the packet. In one example, a customer may choose encrypted packets to utilize or to be associated with a specific security policy. In another example, a customer may prefer a security policy to be based on Class-of-Service (CoS) tags, assigned when classifying packets for queuing prior to transmission, and so on. Note that identification of a security policy may be based on examination of one or more packets. That is, a message may need to be examined for several frames (packets) prior to proper identification of a security policy to be used with the packets, or alternatively may be based on examination of one packet. In turn, the service provider will enable the routers to select a route based on the detected security policy for the packets. For example, the route selection may be based on known security risks associated with network devices supporting the routes, location of routers such as country or city used to establish the routes (e.g., regional preference), etc. For example, if a router has been a target of hackers previously, or is located in a country with questionable physical security and legal practices, or due to specific privacy laws, then a route through such a router may be avoided for a packet that has been associated with a security policy that specifies a high security requirement. In another example, if physical security of network devices such as routers, transmission systems, etc. is relevant for an application, then routes via physically secured network devices may be selected for packets associated with that particular application. For example, routers in public domain, routers in academic settings, routers interconnected via wireless links, and the like may be avoided for packets with such security policy.

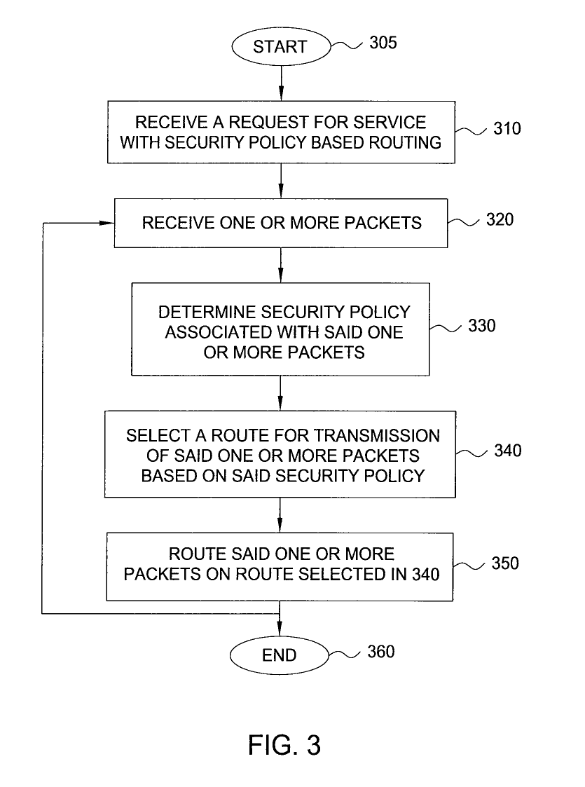

FIG. 3 illustrates a flowchart of a method 300 for providing security policy based route selection. In one embodiment, a service provider provides a service with security policy based routing of packets. For example, the service provider may enable routers to determine security policy associated with one or more packets. For example, a security policy associated with the packets can be deduced from the header of the packets that may define a security policy to be adhered to for the transmission of these packets. In turn, the service provider also enables the routers to then select a route that will most likely meet the requirement of the detected security policy.

Method 300 starts in step 305 and proceeds to step 310. In step 310, method 300 receives a request for service in accordance with security policy based routing from a customer. For example, a customer subscribes to a service with security policy based routing and provides security policy to be applied to the transmission of packets. For example, a customer may interact with application server 114 and specifies encrypted traffic to use a route that only contains routers in a specific country, e.g., US only, North America only, etc. In another example, a customer may specify packets with one or more attributes as provided in the packet headers to be routed on label switched paths or virtual private networks (VPNs). For example, the customer may request encrypted traffic to use a pre-provisioned route, while non-encrypted traffic may use any available routes. The present invention allows packets with more stringent security policy to avoid routers located in a poorly secured physical location, e.g., routers located in suspect regions around the world or suspect regions within a country.

In step 320, method 300 receives one or more packets for transmission. For example, a border element belonging to a service provider may receive one or more packets from a customer for forwarding through the IP/MPLS core network. In another example, a router (e.g., a provider device) in the IP/MPLS core network receives one or more packets from a border element or another router for forwarding towards a destination.

In step 330, method 300 determines a security policy associated with said one or more packets. For example, the method processes the one or more packets, e.g., evaluating the headers of the packets to deduce the security policy associated with the packets. For the example above, the method may determine whether or not the packet is encrypted. If the packets are encrypted, then the method may consult with the customer's previously defined security policy for handling the transmission of encrypted packets and so on.

In step 340, method 300 selects a route for transmission of the one or more packets based on the detected security policy. In one embodiment, the route selection is implemented using a rule based engine for the selection of a route. For example, a rule for selection of a route may specify in accordance with a particular security policy for using a pre-provisioned route across an IP/MPLS network. For example, a plurality of label switched paths may be pre-provisioned for a customer and a packet is forwarded on either one of the pre-provisioned routes or on any available route as applicable, based on the security policy that is detected for the packet. Method 300 then proceeds to step 350.

In step 350, method 300 routes the packet on a route that is selected in step 340. For the above example, encrypted packets are forwarded on a pre-provisioned route that is selected in step 340. The method then ends in step 360 or returns to step 320 to continue receiving more packets.

In one embodiment, the source device (e.g., customer device originating the packets) may provide an indication of a security policy to be used for routing the packets in the header of a packet. For example, when the packet reaches the service provider's network (e.g., reaches the BE), the header may be read to determine the security policy for the packet. If a security policy is not detected or specified, then the packet may be forwarded using the normal process, e.g., using a best route in accordance with the OSPF algorithm and the like. However, if a security policy is specified, then the security policy may be examined and then a route may be selected accordingly.

In one embodiment, the service provider may record the usage of security policy based routing. For example, the billing for a network service such as VoIP or SoIP services may depend on the number of packets that are using security policy based routing as provided by the network service provider. To illustrate, a customer using a VoIP service may specify a higher security requirement for a particular call. In turn, the network service provider may detect the requested security policy associated with that particular call, and will subsequently transmit packets associated with that call using more secured network resources, e.g., selecting a route through the network via secured routers, or using a route that may traverse over a partner network that is more secure when compared to other partner networks. In such instances, a customer may be charged for packets that were treated in accordance with a particular security policy, e.g., a higher charge for security policy that dictates higher security requirements.

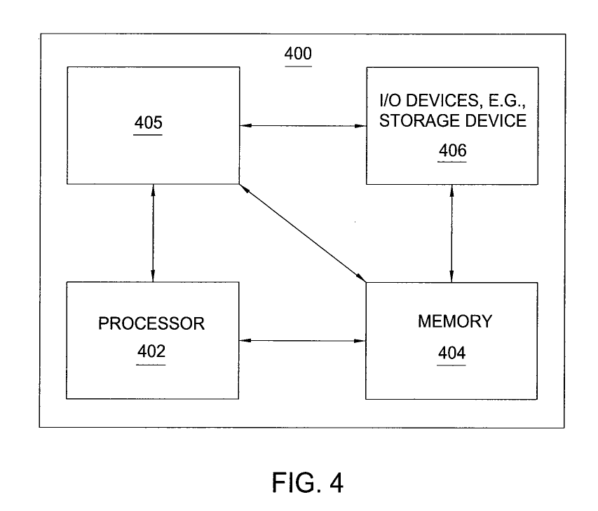

FIG. 4 depicts a high-level block diagram of a general-purpose computer suitable for use in performing the functions described herein. As depicted in FIG. 4, the system 400 comprises a processor element 402 (e.g., a CPU), a memory 404, e.g., random access memory (RAM) and/or read only memory (ROM), a module 405 for providing security policy based route selection, and various input/output devices 406 (e.g., storage devices, including but not limited to, a tape drive, a floppy drive, a hard disk drive or a compact disk drive, a receiver, a transmitter, a speaker, a display, a speech synthesizer, an output port, and a user input device (such as a keyboard, a keypad, a mouse, and the like)).

It should be noted that the present invention can be implemented in software and/or in a combination of software and hardware, e.g., using application specific integrated circuits (ASIC), a general purpose computer or any other hardware equivalents. In one embodiment, the present module or process 405 for providing security policy based route selection can be loaded into memory 404 and executed by processor 402 to implement the functions as discussed above. As such, the present method 405 for providing security policy based route selection (including associated data structures) of the present invention can be stored on a computer readable medium or carrier, e.g., RAM memory, magnetic or optical drive or diskette and the like.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

What is claimed is:

1. A method for routing at least one packet in a communication network, comprising:
receiving at least one packet;
determining a security policy associated with said at least one packet; and
selecting a route for transmission of said at least one packet based on said security policy.

2. The method of claim 1, wherein said communication network is a packet network.

3. The method of claim 1, wherein said selecting said route for transmission selects a pre-provisioned route associated with said security policy.

4. The method of claim 3, wherein said pre-provisioned route comprises at least one of: a label switched path, or a virtual private network.

5. The method of claim 1, wherein said selecting said route for transmission is performed by a router.

6. The method of claim 1, wherein said selecting said route for transmission is performed by a border element.

7. The method of claim 1, wherein said security policy is deduced from information stored in a header of said at least one packet.

8. The method of claim 1, wherein said security policy is defined by a customer of a service provider of said communication network.

9. The method of claim 1, wherein said selecting said route for transmission of said at least one packet based on said security policy is provided as a subscriber service to a customer.

10. The method of claim 9, wherein said subscriber service charges said customer based upon a number of packets that has been transmitted in accordance with said security policy.

11. A computer-readable medium having stored thereon a plurality of instructions, the plurality of instructions including instructions which, when executed by a processor, cause the processor to perform the steps of a method for routing at least one packet in a communication network, comprising:
receiving at least one packet;
determining a security policy associated with said at least one packet; and
selecting a route for transmission of said at least one packet based on said security policy.

12. The computer-readable medium of claim 11, wherein said communication network is a packet network.

13. The computer-readable medium of claim 11, wherein said selecting said route for transmission selects a pre-provisioned route associated with said security policy.

14. The computer-readable medium of claim 13, wherein said pre-provisioned route comprises at least one of: a label switched path, or a virtual private network.

15. The computer-readable medium of claim 11, wherein said selecting said route for transmission is performed by a router.

16. The computer-readable medium of claim 11, wherein said selecting said route for transmission is performed by a border element.

17. The computer-readable medium of claim 11, wherein said security policy is deduced from information stored in a header of said at least one packet.

18. The computer-readable medium of claim 11, wherein said security policy is defined by a customer of a service provider of said communication network.

19. The computer-readable medium of claim 11, wherein said selecting said route for transmission of said at least one packet based on said security policy is provided as a subscriber service to a customer.

20. An apparatus for routing at least one packet in a communication network, comprising:
means for receiving at least one packet;
means for determining a security policy associated with said at least one packet; and
means for selecting a route for transmission of said at least one packet based on said security policy.
